(19) United States
(12) Patent Application Publication
(10) Pub. No.: US 2007/0143459 A1
(43) Pub. Date: Jun. 21, 2007

(54) Protection of privacy-sensitive information through redundancy, encryption and distribution of information

(75) Inventors: Harold Batteram, Kortenhoef (NL); Dirk-Jaap Plas, Enschede (NL)

Correspondence Address: PATTERSON & SHERIDAN, LLP/;LUCENT TECHNOLOGIES, INC, 595 SHREWSBURY AVENUE, SHREWSBURY, NJ, 07702, US

(73) Assignee: Lucent Technologies Inc.

(21) Appl. No.: 11/311,070

(22) Filed: Dec. 19, 2005

(51) Int. Cl. G06F 15/173

(52) U.S. Cl. 709/223

(57) ABSTRACT

A method and system for protecting privacy-sensitive information through redundancy, encryption and distribution of information is provided. Information to be stored is received from one of a number of devices. The information is divided into a number of segments that are stored distributed across a set of storage facilities that are nodes on a network and associated with the devices. A virtual disk device driver represents the set of storage facilities and communicates with a master node on the network. The master node maintains an index table that stores the location the segments of a virtual disk. Each segment has an identifier and a version. The virtual disk is controlled by the virtual disk driver. The device runs the virtual disk device driver to store information that is divided into the segments.

### FIELD OF THE INVENTION

The present invention relates generally to data networking and, in particular, relates to a method and system for protecting privacy-sensitive information through redundant, encrypted and distributed storage of information.

### BACKGROUND OF THE INVENTION

These days, people have more and more electronic devices, such as personal computers (PCs), personal digital assistants (PDAs), cell phones, and other electronic devices that use traditional ways of storing and accessing information. Each device stores information at a different storage facility than the other devices so that information is not commonly accessible. Some examples of storage facilities include a file transfer protocol (FTP) server, e-mail accounts, shared network drives and other storage locations. Not all storage facilities have appropriate security mechanisms for storing privacy-sensitive information. Some storage facilities are not permanent so that the information stored there may not remain accessible.

### SUMMARY

Various deficiencies of the prior art are addressed by various exemplary embodiments of the present invention of a method and system for protecting privacy-sensitive information through redundancy, encryption and distribution of information.

One embodiment is a method for storing information. Information is received for storage from one of a number of user devices. The information is divided into a plurality of data units that are stored on a plurality of segments. The segments are fixed size data units used to store data. The segments are stored distributed across a set of storage facilities. The storage facilities in the set are nodes on a network and associated with the devices.

Another embodiment is a system for storing information, including a virtual disk device driver and a device. The virtual disk device driver represents a set of storage facilities and communicates with a master node on a network. The master node maintains an index table. The index table stores the location the segments of a virtual disk. Each segment has an identifier and a version. The virtual disk is controlled by the virtual disk driver. The device is capable of running an operating system and the virtual disk device driver. The device runs the virtual disk device driver to store information that is divided into the segments. The device is one of a number of devices that are associated with the storage facilities.

### BRIEF DESCRIPTION OF THE DRAWINGS

The teachings of the present invention can be readily understood by considering the following detailed description in conjunction with the accompanying drawings, in which:

FIG. 1 is an illustration of the problem presented in the prior art by various devices and the associated storage facilities;

FIG. 2 is a block diagram illustrating an exemplary embodiment 200 of a method for protecting privacy-sensitive information through redundancy, encryption and distribution of information;

FIG. 3 is a block diagram illustrating another exemplary embodiment 300 of a method for protecting privacy-sensitive information through redundancy, encryption and distribution of information;

FIG. 4 is a flow chart showing an exemplary embodiment of a method of performing an initialization phase;

FIG. 5 is a flow chart showing an exemplary embodiment of a method of performing a reading phase;

FIG. 6 is a flow chart showing an exemplary embodiment of a method of performing a writing phase;

FIG. 7 is a high level block diagram showing a computer. To facilitate understanding, identical reference numerals have been used, where possible, to designate identical elements that are common to the figures.

### DETAILED DESCRIPTION OF THE INVENTION

The invention is primarily described within the general context of exemplary embodiments of a method and system for protecting privacy-sensitive information through redundancy, encryption and distribution of information. However, those skilled in the art and informed by the teachings herein will realize that the invention is applicable generally to all kinds of information whether private or not, data networking, virtual disks, and interconnecting computing devices, even if the optional redundancy and encryption are not used.

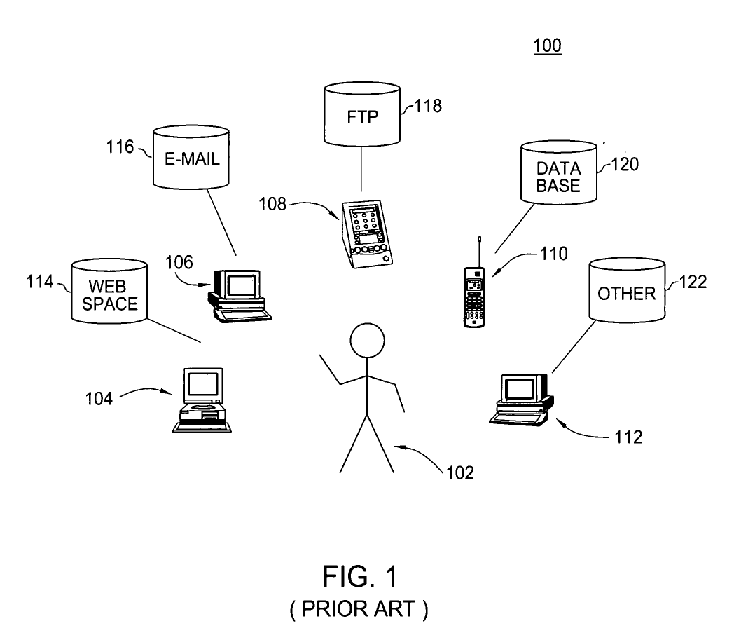

FIG. 1 illustrates the problem presented 100 in the prior art by various devices and their associated storage facilities. A typical user 102 owns many different kinds of devices 104, 106, 108, 110, 112 that store information at different storage facilities 114, 116, 118, 120, 122. For example, a home computer 104 stores information at a web space 114. A work computer 106 stores information at an e-mail server 116. A PDA 108 stores information at an FTP server. A cell phone 110 stores information at a database 120. Any other device 112 stores information at another storage facility 122.

One exemplary embodiment is an abstraction layer for the user 102 that provides the user 102 with one uniform view on a set of storage facilities that are accessible by the user 102. This abstraction hides details from the user 102, such as communication with different types of storage facilities 114, 116, 118, 120, 122, where information is stored, and the like. From the perspective of the user 102, the abstraction layer is just another storage facility. The uniform view is a virtual storage system, implementable as a software layer, i.e., the abstraction layer. The user 102 uses the abstraction layer to store and retrieve information from the set of storage facilities in a way that is similar to saving and loading files. The abstraction layer divides the information, encrypts the information, and distributes it redundantly over the set of storage facilities. For several reasons, this protects the privacy of the information, even if the storage facilities cannot be completely trusted. First, the information is divided so that any one piece of information does not provide the whole information. Second, the information is encrypted, making it difficult for others to understand. Third, the information is distributed and it is difficult to find where the rest of the information is located.

This exemplary embodiment of the abstraction layer stores information distributed across different storage facilities 114, 116, 118, 120, 122. These storage facilities 114, 116, 118, 120, 122 are not necessarily the same type of storage facility. Storage facilities 114, 116, 118, 120, 122 can be of any type, such as e-mail accounts, web spaces, file systems, shared network drives, and other types of storage facilities. Storage devices in the set of storage facilities may be added or removed. The information stored is divided into different parts that are encrypted and redundantly distributed across the set of storage facilities. The information is accessible by a virtual storage system, which may be accessed by the user 102 from different locations and by various devices 104, 106, 108, 110, 112.

One exemplary embodiment includes an intermediate layer, i.e., a virtual disk device driver, which stores information to maintain privacy and availability. The information is divided into segments, encrypted, and stored redundantly. From the perspective of the user, the virtual disk device driver hides all of the details about the various storage facilities. The user can store a file to the virtual disk just as the user stores a file to any disk.

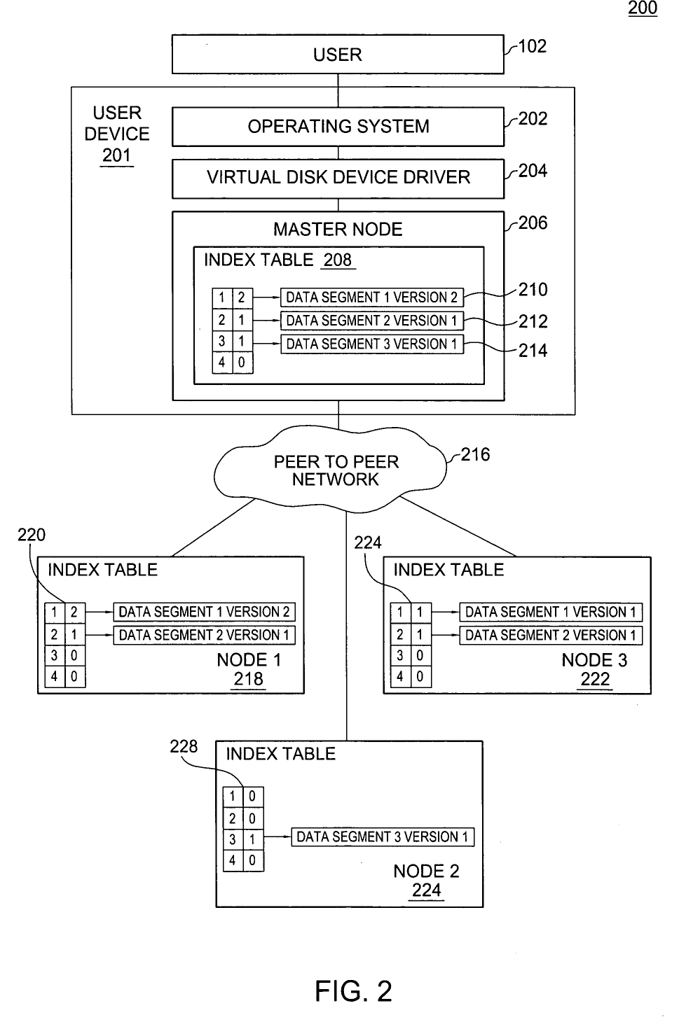

FIG. 2 illustrates an exemplary embodiment 200 of a method for protecting privacy-sensitive information through redundancy, encryption and distribution of information. The user 102 accesses a user device 201 (e.g., one of the user devices 104, 106, 108, 110, 112 in FIG. 1). The user device 201 includes an operating system 202 that accesses a virtual disk device driver 204. The virtual disk device driver 204 provides access to a virtual disk drive that functions for the user as a regular, local disk drive. However, the virtual disk device driver 204 accesses remote storage facilities over a network 216 connecting the various storage facilities 114, 116, 118, 120, 122 of the various devices 104, 106, 108, 110, 112 (see FIG. 1). The present invention is not limited to any particular kinds of operating systems, device drivers, storage facilities, or networks. In this exemplary embodiment, network 216 is a peer-to-peer network, but the network may be any type of network.

As shown in FIG. 2, the virtual disk device driver 204 is located on a user device that acts as a master node 206. The master node 206 is one of the nodes in the network 216. The virtual disk device driver 204 maintains an index table 208 that stores the location of each segment 210, 212, 214 that belongs to the virtual disk. Each segment has an identifier, such as a segment number, and a version number. Each participating node 218, 222, 224 in the network 216 maintains an index table 220, 224, 228 for the segments it holds and the version number for each segment. The number of segments and the data size of each segment is a user configurable property of the virtual disk device driver 204.

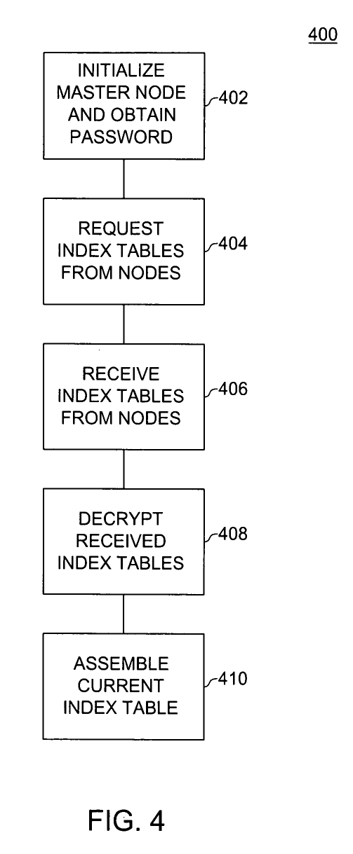

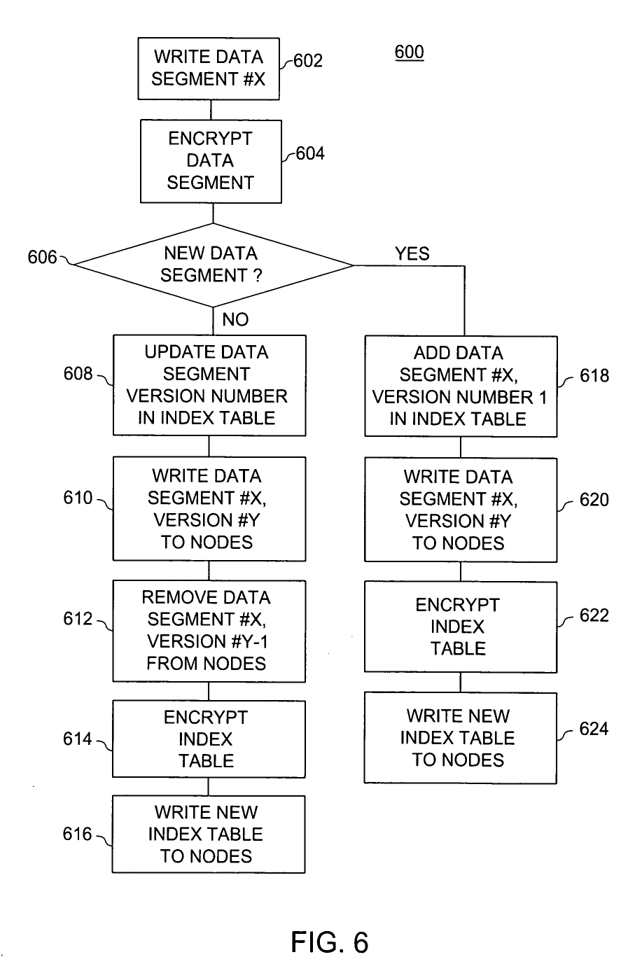

During initialization (see FIG. 4), the master node 206, requests the index tables 220, 224, 228 of the other nodes 218, 222, 224 in the network 216. When a segment is rewritten by new data (see FIG. 6), its version number is updated (e.g., increases) and old segments can be discarded. The master node 206 assembles the most recent version of the index table 208 by using the latest (e.g., highest) segment version numbers of each index table 208 received. Nodes that contain out of date segment version numbers (e.g., segment 1, version 1 on node 3 222) can be notified to discard the segment or to update to the latest version of the segment.

For example, in FIG. 2, the master node 206 has assembled a virtual disk having three segments 210, 212, 214. Segment 1 210 has a version number of 2 and is retrieved from node 1 218. Segment 2 212 has a version number of 1 and is retrieved from node 3 222. Segment 3 214 has a version number of 1 and is retrieved from node 2 224. Segment number 2 212 is also redundantly available from node 1 218.

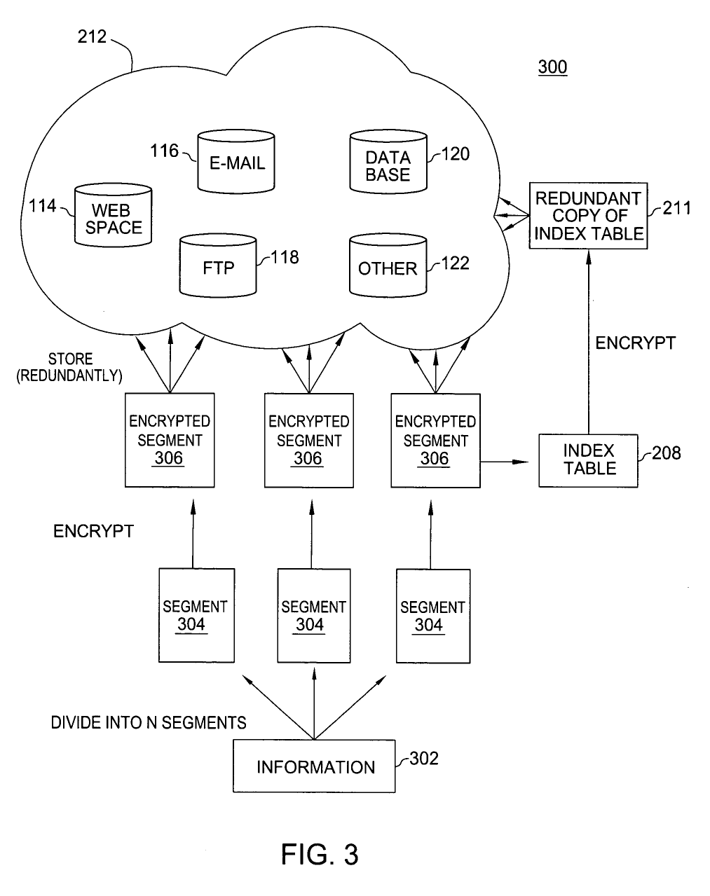

FIG. 3 illustrates another exemplary embodiment 300 of a method for protecting privacy-sensitive information through redundancy, encryption and distribution of information. Information 302 in a file is divided into data units that are stored on a number, n, of segments 304, which are fixed size data units used to store data and may be, for example, sectors of a disk. The segments 304 are distributed across a set of storage facilities 308. The segments 304 may be encrypted 306 and redundantly stored. The index table 208 may also be encrypted and redundantly stored 211.

One exemplary embodiment is a method of storing information using this intermediate layer, i.e., the virtual disk device driver 204. Information 302, such as a file, is received by the virtual disk device driver 204 along with information about the degree of privacy and availability needed by the user 102, e.g., low, medium, high for both privacy and availability. Based on this information, the intermediate layer determines how to store the information. How to store the information is determined by considering the appropriate redundancy to apply, the appropriate division to apply, and the appropriate encryption to apply, or whether to apply them at all. Determining the appropriate redundancy depends on what extent and whether the segments should be replicated and where the segments should be stored. Determining the appropriate division of information depends on whether and to what extent the information should be divided and the size of the segments, among other things.

If the availability is important, it is less desirable to divide the information and more desirable to store it redundantly over the set of storage facilities. If privacy is important, it is desirable to divide the file into many pieces and distribute them across the storage facilities, possibly encrypted, but it is less desirable to store information redundantly. A trade-off is made between privacy and availability, because they have competing interests with respect to dividing information and storing it redundantly. Encryption stands orthogonal to this trade-off can be used to compensate dividing the information. Table 1 below illustrates how the redundancy, encryption, and division of files are influenced by the privacy and availability needs in an exemplary embodiment.

TABLE 1
Influence of privacy and availability on redundancy,
encryption and division of files in an exemplary embodiment.
Privacy

| | | Low | Medium | High |
|---|---|---|---|---|
| Availability | Low | Redundancy | Redundancy | Redundancy |
| | | low | low | low |
| | | Encryption | Encryption | Encryption |
| | | low | medium | high |
| | | Division | Division | Division |
| | | low | medium | high |
| | Medium | Redundancy | Redundancy | Redundancy |
| | | medium | medium | medium |
| | | Encryption | Encryption | Encryption |
| | | low | medium | high |
| | | Division | Division | Division |
| | | low | low | low |
| | High | Redundancy | Redundancy | Redundancy |
| | | high | high | high |
| | | Encryption | Encryption | Encryption |
| | | low | medium | high |
| | | Division | Division | Division |
| | | low | low | low |

Another exemplary embodiment is a virtual hard disk that embodies the principle of distributed storage. In a conventional hard disk, the physical data storage area is divided into a number of fixed size sectors. When a single file is stored on the hard disk, it spans one or more sectors. A disk device driver in a computer is software that handles read and write access to the data on disk. The virtual hard disk also uses fixed sized segments to store data. However, these segments are stored on other computer nodes in the network, rather than on one physical hard disk. A virtual disk device driver hides the location of the sectors from the operating system. The operating system uses the virtual disk device driver to access the data on the virtual hard disk just as it would on a regular hard disk.

In this exemplary embodiment, a virtual disk device driver 204 uses a peer-to-peer network 216 to store its data segments 210, 212, 214 redundantly across nodes 218, 222, 224 in the peer-to-peer network 216. Peer-to-peer networks 216 have any number of nodes 218, 22, 224 that cooperate to store and locate data. These networks 216 are often used for file sharing. Peer-to-peer networks 216 are dynamic in the sense that nodes 218, 222, 224 can join or leave the network 216 at any time. Files are, therefore, typically stored as redundant copies across multiple nodes 218, 222, 224 to reduce the risk that a file cannot be found, because the node storing the data is offline.

In this exemplary embodiment, the virtual disk device driver 204 stores multiple copies of segments 304, 306 across nodes in the peer-to-peer network 216. For security reasons, each segment is encrypted 306 before it is sent to the network 216. An encryption key may be configured in the virtual disk device driver 204 and provided by the user 102 during installation.

FIG. 4 shows an exemplary embodiment of a method of performing an initialization phase. At 402, the master node is initialized and a password is obtained. At 404, index tables are requested from the nodes. At 406, index tables are received from the nodes. At 408, the received index tables are decrypted. At 410, the current index table is assembled.

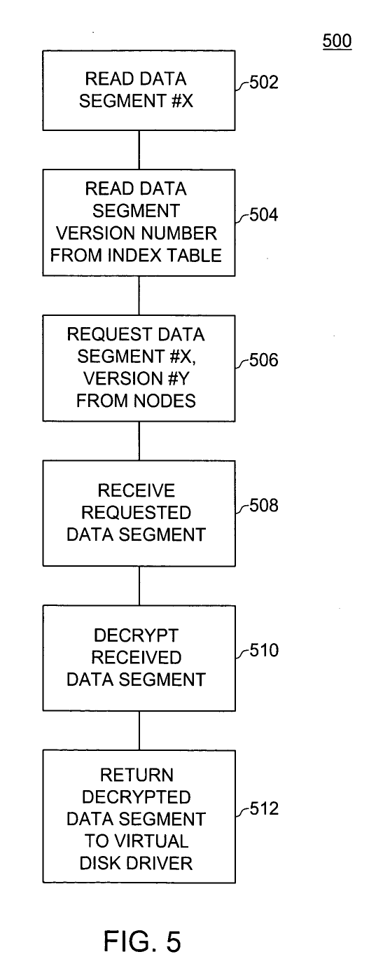

FIG. 5 shows an exemplary embodiment of a method of performing a reading phase. At 502, a particular data segment, e.g., #x, is read. At 504, the data segment version number is read from the master index table. At 506, data segment #x version #y is requested from the nodes. At 508, the requested data segment is received and, at 510, it is decrypted. At 512, the decrypted data segment is returned to the virtual disk driver.

FIG. 6 shows an exemplary embodiment of a method of performing a writing phase. At 602, a data segment is written and, at 604, it is encrypted. At 606, it is determined whether it is a new data segment.

If it is not a new data segment at 606, then, at 608 the data segment version number is updated in the index table. At 610, data segment #x version #y is written to the nodes. At 612, data segment #x version #y-1 is removed form the nodes. At 614, the index table is encrypted. At 616, the new index table is written to the nodes.

If it is a new data segment at 606, then, at 618, data segment #x version number 1 is added to the index table. At 620 data segment #x version #y is written to the nodes. At 622 the index table is encrypted. At 624, the new index table is written to the nodes.

There are many benefits to the various exemplary embodiments. The virtual disk device driver is transparent to the operating system. The operating system treats the virtual disk just as it treats any other disk. The data is stored redundantly across a number of nodes, reducing the risk of data loss. The redundancy factor can be set to balance storage needs with the risk of data loss. The virtual disk device driver concept can be applied to any operating system, independent of the file system used, by providing the appropriate virtual disk device driver for the operating system. Nodes in the peer-to-peer network do not store complete files, but only one or more data segments. Each segment contains a fixed amount of data, which can be either one or multiple files, or part of a larger file. Segment encryption can be used to provide data security.

In the prior art, some devices 104, 106, 108, 110, 112 may have ad hoc direct access to specific types of information, depending on the capabilities of a particular device 104, 106, 108, 110, 112. However, no particular device has access to all the different storage facilities 114, 116, 118, 120, 122 of the other devices or knowledge of the particular protocols or data formats necessary for information exchange. Prior art encryption mechanisms, such as encrypted file systems, file encryption standards, user logon procedures and the like, do not all support the highest level of security needed to store privacy-sensitive information. Prior art encryption mechanisms only apply to one local system within one administrative domain and do not apply to other environments.

Exemplary embodiments of the present invention have many advantages over the prior art, including securely store privacy-sensitive information in a potentially untrusted environment. Exemplary embodiments combine storage of privacy-sensitive information in an infrastructure that cannot be completely trusted with integration of various types of data storage facilities into one virtual storage system. The virtual storage system can be dynamically extended with other storage facilities and remains accessible from any device, unlike the prior art. Exemplary embodiments provide users with a way to manage their information and mechanisms to securely store privacy-sensitive information reliably. Exemplary embodiments of the present invention can help prevent a user from losing data when, for example, a disk crashes on his home computer.

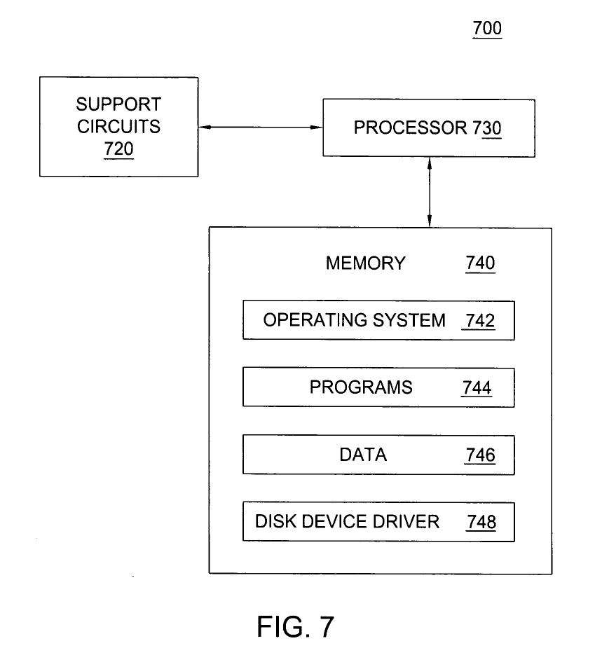

FIG. 7 is a high level block diagram showing a computer. The computer 700 may be employed to implement embodiments of the present invention. The computer 700 comprises a processor 730 as well as memory 740 for storing various programs 744 and data 746. The memory 740 may also store an operating system 742 supporting the programs 744. The memory 740 also includes a disk device driver 748.

The processor 730 cooperates with conventional support circuitry 720 such as power supplies, clock circuits, cache memory and the like as well as circuits that assist in executing the software routines stored in the memory 740. As such, it is contemplated that some of the steps discussed herein as software methods may be implemented within hardware, for example, as circuitry that cooperates with the processor 730 to perform various method steps. The computer 700 also contains input/output (I/O) circuitry that forms an interface between the various functional elements communicating with the computer 700.

Although the computer 700 is depicted as a general purpose computer that is programmed to perform various functions in accordance with the present invention, the invention can be implemented in hardware as, for example, an application specific integrated circuit (ASIC) or field programmable gate array (FPGA). As such, the process steps described herein are intended to be broadly interpreted as being equivalently performed by software, hardware, or a combination thereof.

The present invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a broadcast media or other signal bearing medium, and/or stored within a working memory within a computing device operating according to the instructions.

While the foregoing is directed to various embodiments of the present invention, other and further embodiments of the invention may be devised without departing from the basic scope thereof. As such, the appropriate scope of the invention is to be determined according to the claims, which follow.

What is claimed is:

1. A method for storing information, comprising:
receiving information for storage from one of a plurality of user devices;
dividing the information into a plurality of data units that are stored on a plurality of segments, the segments being fixed size data units used to store data;
storing the segments distributed across a set of storage facilities, the storage facilities in the set being nodes on a network and associated with the devices.

2. The method of claim 1, further comprising:
encrypting the segments before the segments are stored.

3. The method of claim 1, wherein the segments are stored redundantly.

4. The method of claim 1, further comprising:
reading the information on one of the user devices through a virtual storage system.

5. The method of claim 1, wherein
updating the information on one of the user devices through a virtual storage system.

6. The method of claim 1, wherein a virtual disk device driver provides access to the information.

7. A system for storing information, comprising:
a virtual disk device driver on a master node for representing a set of storage facilities and for maintaining an index table, the virtual disk device driver being located on a user device that acts as the master node in a network, the index table storing a location of a plurality of segments of a virtual disk, each segment having an identifier and a version, the virtual disk being controlled by the virtual disk driver;
a user device capable of running an operating system and the virtual disk device driver to store information that is divided into a plurality of data units that are stored on the segments, the user device being one of a plurality of devices, the devices being associated with the storage facilities.

8. The system of claim 7, wherein the version of the segment is updated when data is written to the segment.

9. The system of claim 8, wherein the master node assembles the index table from a plurality of index tables stored on each of the user devices.

10. The system of claim 9, wherein the master node assembles the index table using the latest version of each segment from the index tables stored on the user devices.

11. The system of claim 7, wherein the segments are encrypted and the encrypted segments are stored redundantly across the virtual disk.

12. The system of claim 1, further comprising:
a redundant copy of the index table that is encrypted and stored across the virtual disk.

13. A computer readable medium storing instructions for performing a method for storing information, the method comprising:
receiving information for storage from one of a plurality of user devices;
dividing the information into a plurality of data units that are stored on a plurality of segments, the segments being fixed size data units used to store data;
storing the segments distributed across a set of storage facilities, the storage facilities in the set being nodes on a network and associated with the devices.

14. The computer readable medium of claim 13, further comprising:
encrypting the segments before the segments are stored.

15. The computer readable medium of claim 13, wherein the segments are stored redundantly.

16. The computer readable medium of claim 13, further comprising:
reading the information on one of the user devices through a virtual storage system.

17. The computer readable medium of claim 13, wherein
updating the information on one of the user devices through a virtual storage system.

18. The computer readable medium of claim 13, wherein a virtual disk device driver provides access to the information.
